(19) United States
(12) Patent Application Publication
(10) Pub. No.: US 2011/0192035 A1
(43) Pub. Date: Aug. 11, 2011

(54) COMPOUND-ACTION PRUNING TOOLS

(76) Inventor: Wen Ger Chen, Taichung City (TW)

(21) Appl. No.: 12/702,355

(22) Filed: Feb. 9, 2010

(51) Int. Cl. A01G 3/02

(52) U.S. Cl. 30/251

(57) ABSTRACT

Hand pruning tools include a force-multiplying mechanism and protected return spring. A proximal handle is coupled to a jaw, and a blade component is pivotably coupled to the jaw through a blade pivot. A distal handle is pivotably coupled to the proximal handle through a handle pivot spaced apart from the blade pivot. The distal handle has a longitudinal cavity with a slot pin. The blade component has one end with a blade that engages with the jaw, and an opposing end with an elongated slot that engages with the slot pin. A return spring disposed in the cavity pulls on the opposing end of the blade component, thereby facilitating a closed configuration wherein the slot pin is in the slot toward the blade pivot and the blade is adjacent the jaw, and an open configuration wherein the slot pin is in the slot away from the blade pivot and the blade is spaced apart from the jaw.

### FIELD OF THE INVENTION

This invention relates generally to hand tools and garden tools and, in particular, to pruning tools having a force-multiplying mechanism and an elegant design with few component parts.

### BACKGROUND OF THE INVENTION

There are numerous designs for hand tools, including manually operated pruning shears. Some of these include links or other mechanisms to provide for a force-multiplying or compound action. However, most of these tools use excessive moving parts, and if a return spring is provided, it is ordinarily exposed, which may pinch a user or collect dirt. Thus, despite available and patented configurations, the need nevertheless remains for improved pruners.

### SUMMARY OF THE INVENTION

This invention resides in hand pruning tools which include a force-multiplying mechanism and protected return spring. A proximal handle is coupled to a jaw, and a blade component is pivotably coupled to the jaw through a blade pivot. A distal handle is pivotably coupled to the proximal handle through a handle pivot spaced apart from the blade pivot. The distal handle has a longitudinal cavity with a slot pin. The blade component has one end with a blade that engages with the jaw, and an opposing end with an elongated slot that engages with the slot pin.

A return spring disposed in the cavity pulls on the opposing end of the blade component, thereby facilitating a closed configuration wherein the slot pin is in the slot toward the blade pivot and the blade is adjacent the jaw, and an open configuration wherein the slot pin is in the slot away from the blade pivot and the blade is spaced apart from the jaw. The return spring may be nested yet visible within the distal handle, or the spring may be hidden behind a panel.

In the preferred embodiment, the jaw forms part of jaw component attached to the proximal handle. The jaw may bypass the blade, forming a bypass pruner configuration, or the jaw may form an anvil against which the blade strikes. The proximal and distal handles may operated with a single hand of a user, or the handles may be lengthened and operated with both hands as a lopping tool.

### BRIEF DESCRIPTION OF THE DRAWINGS

FIG. 1 depicts a first side of a bypass pruner according to the invention in an open position;

FIG. 2 shows the bypass pruner of FIG. 1 in a closed position;

FIG. 3 depicts the other side of the pruner shown in FIG. 1 in an open position;

FIG. 4 depicts the other side of the pruner shown in FIG. 1 in a closed position;

FIG. 5 is an oblique view seen from the first side and above rear;

FIG. 6 is an oblique view seen from the other side and above front;

FIG. 7 is an oblique view seen from the first side and above front;

FIG. 8 is an oblique view seen from the other side and above rear

FIG. 9 is a back view of the bypass pruner embodiment;

FIG. 10 is a front view;

FIG. 11 is a top view;

FIG. 12 is a bottom view;

FIG. 13 is a detail drawing of a blade component;

FIG. 14 is a detail drawing of a jaw component;

FIGS. 15A-15C are schematic diagrams used to illustrate the way in which the tool operates;

FIG. 16 shows the pruner as seen in FIG. 1 with some of the components rendered in transparent form to better illustrate the inner workings of the device;

FIG. 17 shows the closed pruner as seen in FIG. 2 with some of the components rendered in transparent form to better illustrate the inner workings of the device; and

FIG. 18 shows an alternative embodiment of the invention having a more exposed return spring and anvil cutters; and

### DETAILED DESCRIPTION OF THE INVENTION

This invention resides in manually operated hand tools, pruning shears in particular. As described herein, the basic structures and principles of the invention may be applied to short- and long-handled versions, with bypass or anvil blade configurations. In all embodiments, the invention facilitates compound (i.e., force-multiplying) cutting action with a hidden or nested return spring utilizing relatively few component parts, certain of which are identified in the table below:
100 proximal handle component
102 proximal handle insert
104 distal handle component
105 distal handle axis
103 distal handle insert
106 blade
107 blade component
108 jaw
109 jaw component
110 blade pivot fastener
112 handle pivot fastener
116 slot pin/fastener
118 return spring
130 slot
131 slot axis
132 upper spring connection
133 lower spring connection
136 slot pin aperture
120 latch
122 latch hook
124 latch catch
142 jaw component shank
144 handle pivot aperture
146 blade pivot aperture

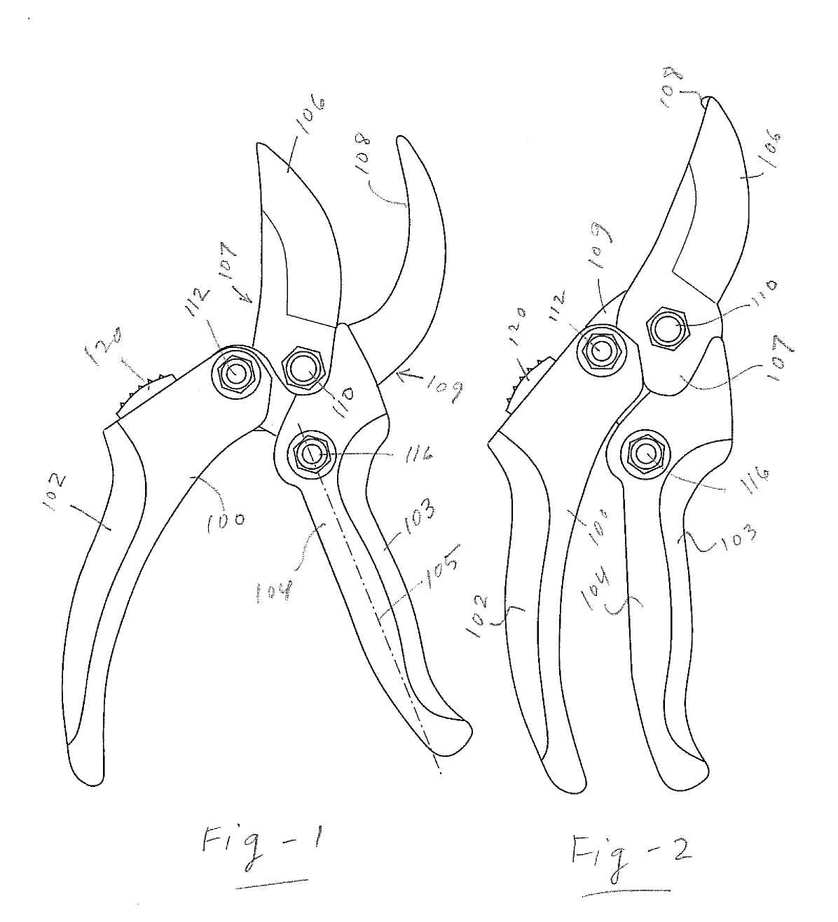

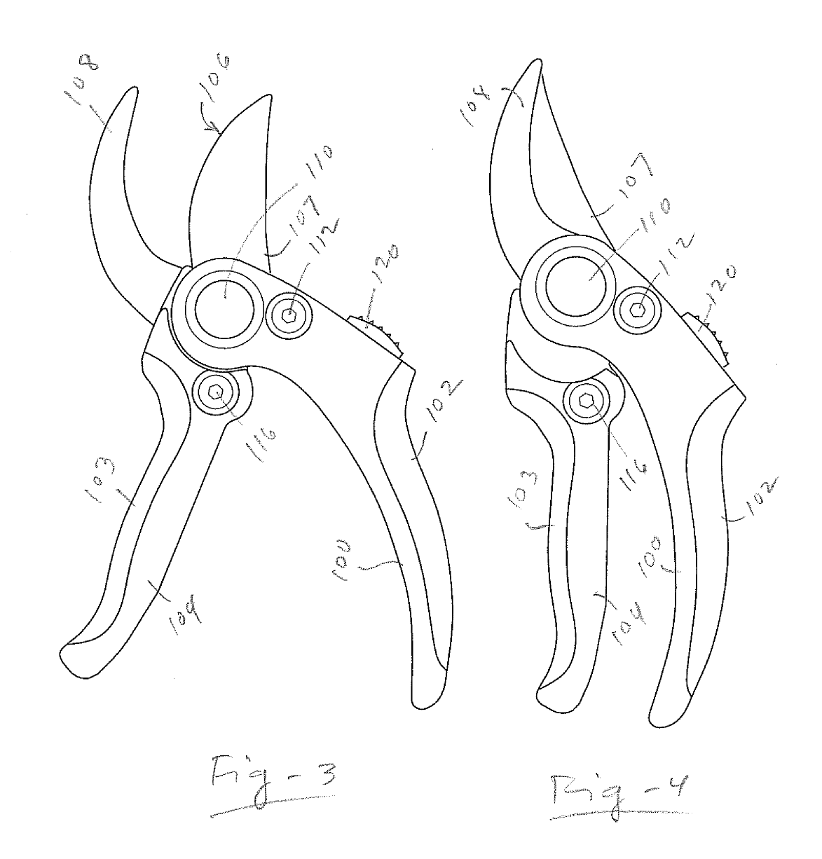

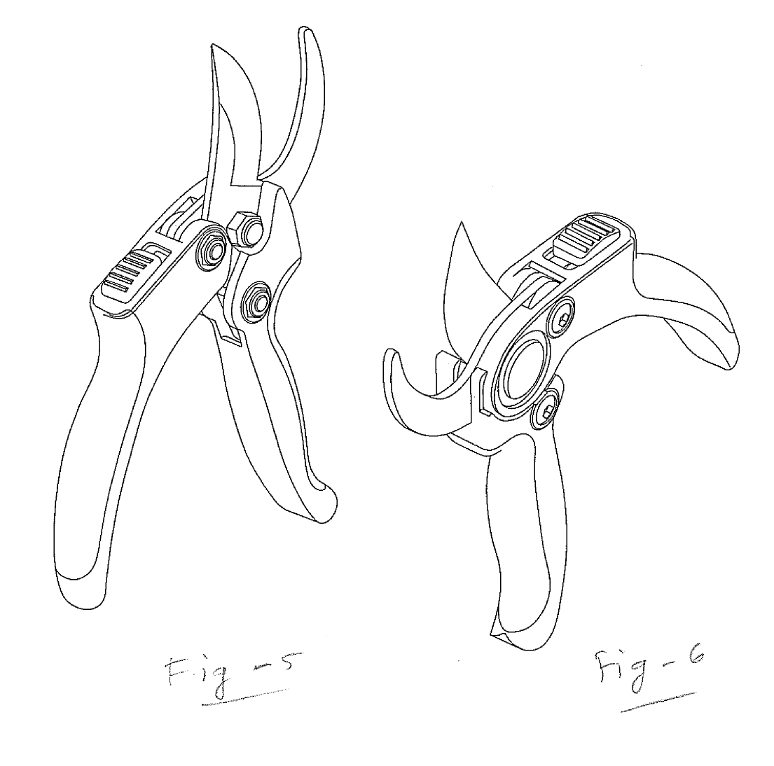

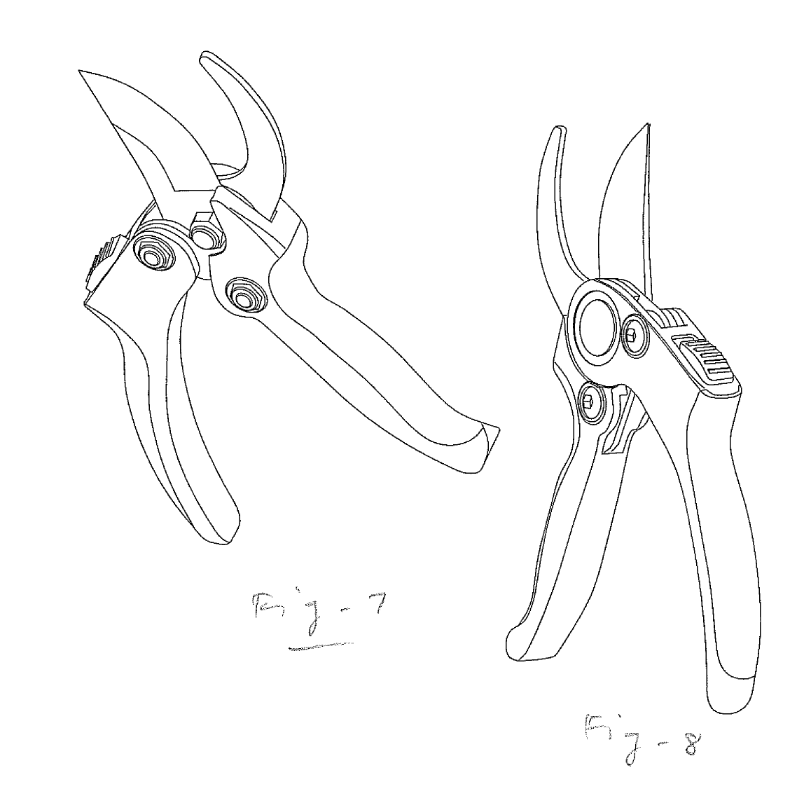

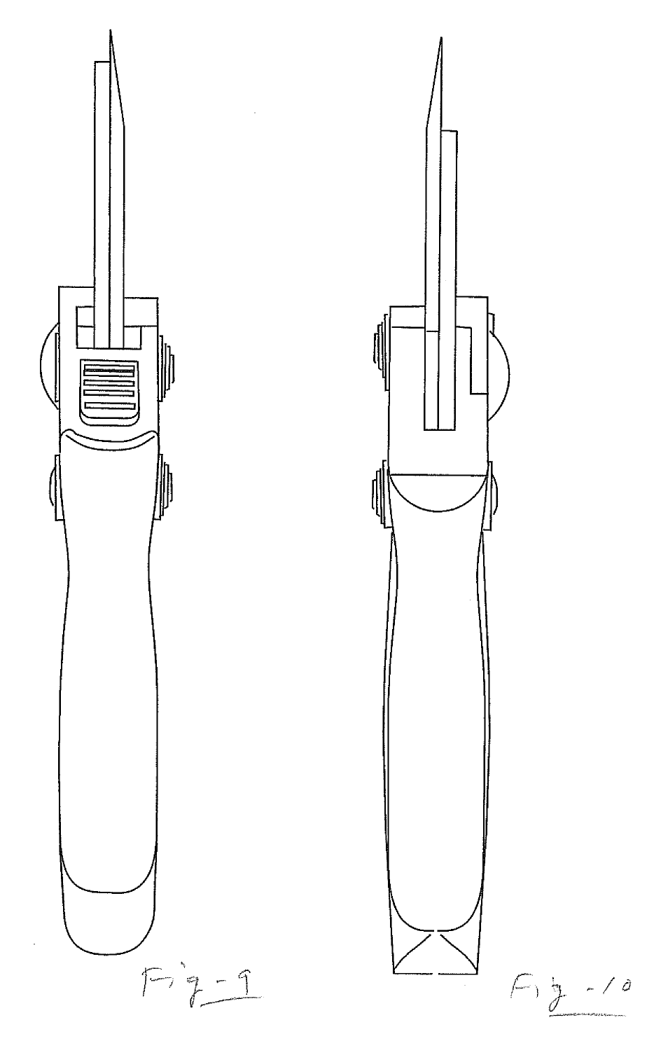

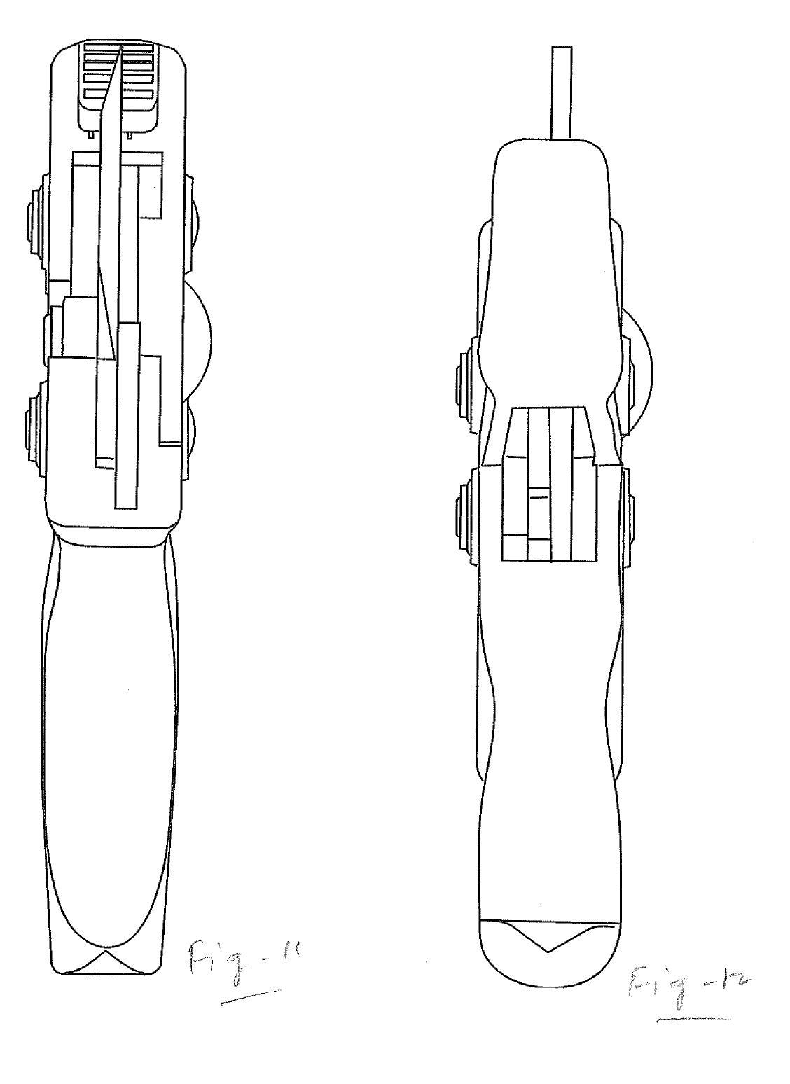

FIG. 1 depicts a first side of a short-handled bypass pruner in accordance with the invention, shown with the blade open. FIG. 2 shows the tool with the blade closed. FIGS. 3, 4 depict the other side of the tool with the blade and jaw open and closed, respectively. FIG. 5 is an oblique view seen from the first side and above rear. FIG. 6 is an oblique view seen from the other side and above front. FIG. 7 is an oblique view seen from the first side and above front. FIG. 8 is an oblique view seen from the other side and above rear. FIG. 9 is a back view; FIG. 10 is a front view; FIG. 11 is a top view; and FIG. 12 is a bottom view.

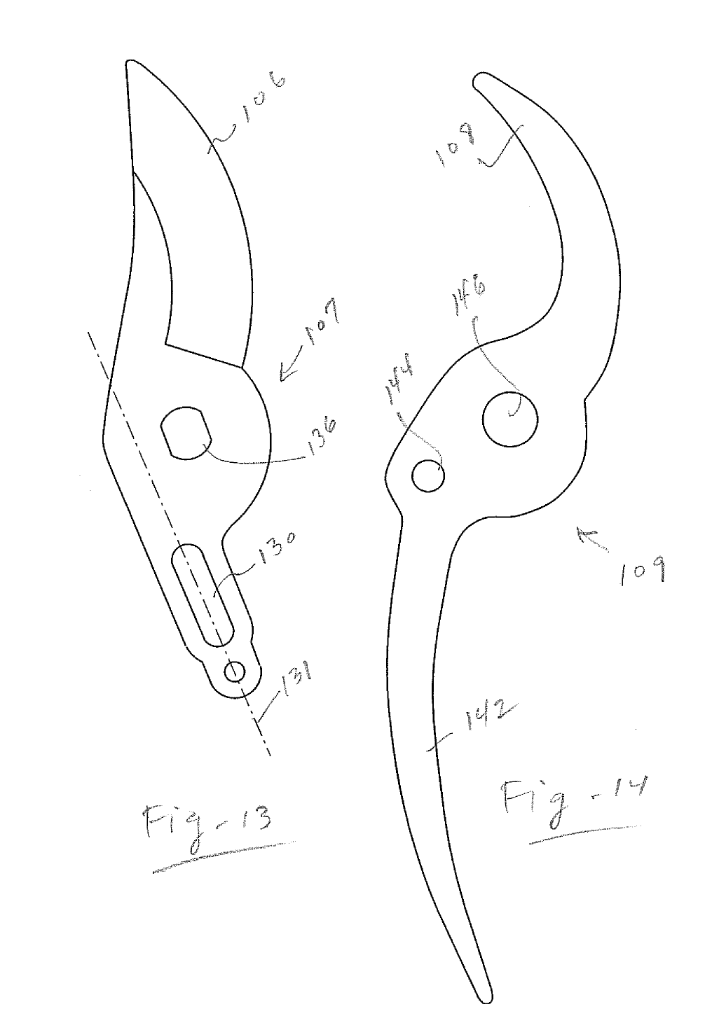

The tool includes a proximal handle component 102 and a distal handle component 104 defining a longitudinal axis 105. The handle components 102, 104 pivot about handle pivot fastener 112. A blade 106 is formed on a blade component 107 and jaw 108 forms part of a jaw component 109. The blade and jaw components 107, 109, depicted in FIGS. 13, 14, respectively, pivot about blade pivot fastener 110. A return spring mechanism described in detail below automatically causes the blade and jaw to open to the condition shown in FIG. 1 if the latch 120 is not engaged.

All of the various parts may be fabricated from any appropriate materials, including metals and plastics. In the preferred embodiments, the blade and jaw components 107, 109, spring 118 and the fasteners may be made of metal, most preferably steel, including stainless steel. Other components such as the handle components may be constructed of a hard plastic such as nylon or ABS. The handle components may have compressible or resilient inserts 102, 103. The fasteners, depicted as nuts and bolts, may include washers, lock washers, and/or nylon threads to maintain tightness and/or prevent loosening to ensure smooth operation.

FIG. 13 is a detail drawing of the blade component 107, and FIG. 14 is a detail drawing of the jaw component 109. Blade component 107 includes a slot 130 defined by axis 131 to receive slot pin/fastener 116, and a hole 136 to receive blade pivot fastener 110. Hole 136 is preferably non-round so that blade pivot fastener 110 rotates along with blade component 107. Jaw component 109 includes a curved shank 142, a hole 144 to receive handle pivot fastener 112, and a hole 146 to receive blade pivot fastener 110. The shank 142 of jaw piece 109 is nested in proximal handle 100 such that the proximal handle and jaw move as a unit.

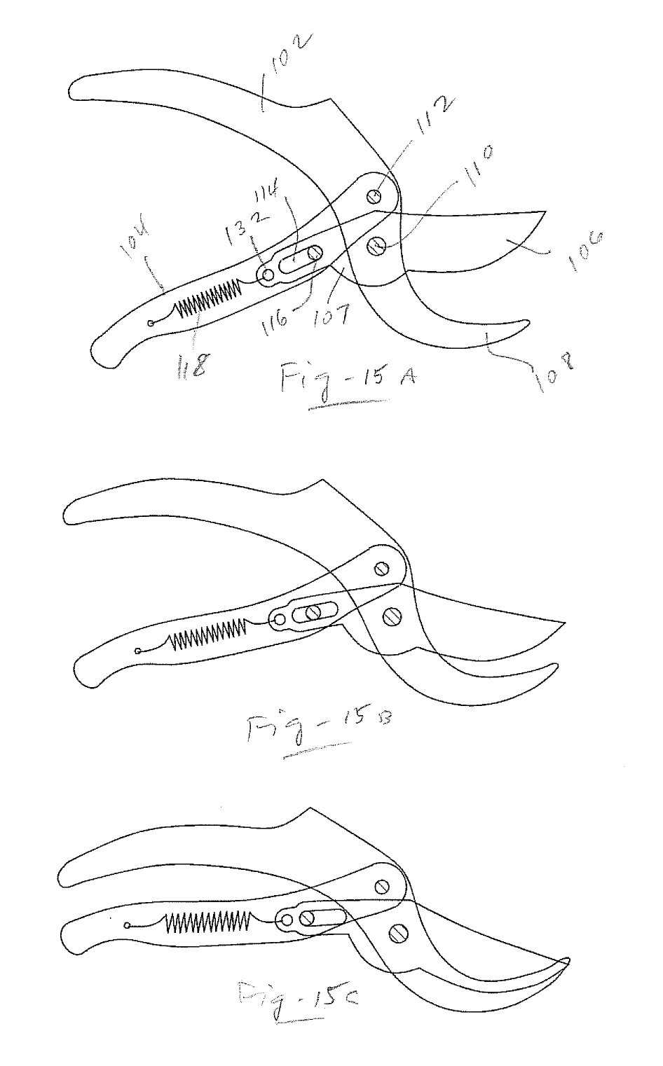

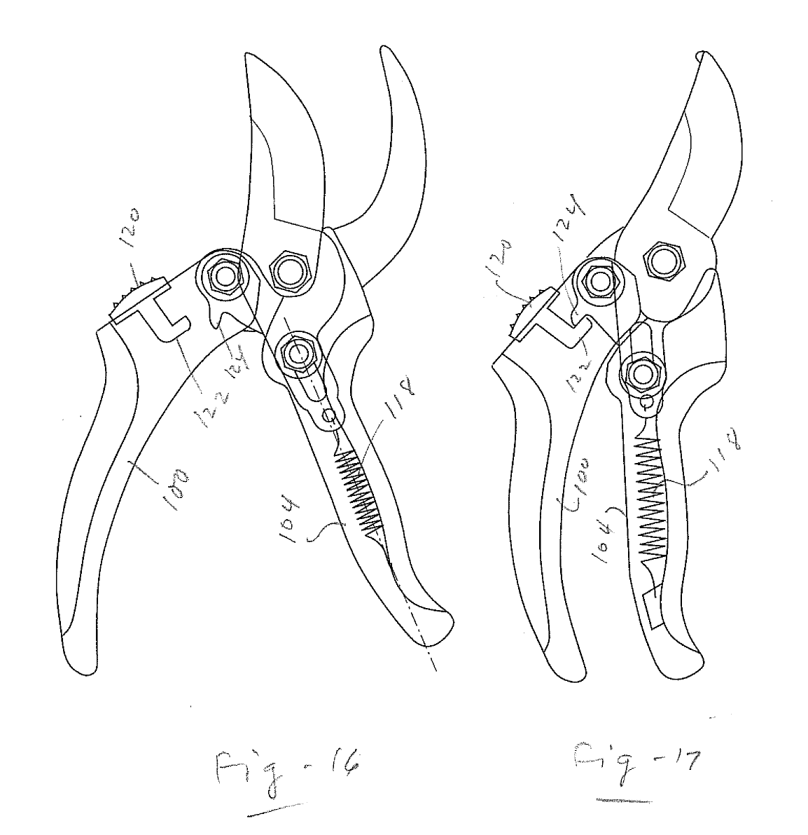

FIGS. 15A-15C are schematic diagrams used to illustrate the way in which the tool operates. In these drawings, the proximal handle 100 and jaw 108 are depicted as a single unit since they move in unison. Indeed, the proximal handle 100 and jaw component may be constructed as a unitary piece; however, separate materials are used so the handle can be plastic and the jaw may be metal. In the relaxed, unlatched state of FIG. 15A, return spring 118 pulls on the blade piece 107 through attachment hole 132, causing slot pin/fastener 116 to ride upward along slot 114, urging the handles and blade/jaw apart. As shown in FIG. 15B, squeezing the handles 100, 104 causes the slot-containing lower portion of the blade piece to slide longitudinally within distal handle 104, thereby extending spring 118 and closing the blade and jaw, as best seen in FIG. 15C. Note that during operation, the axis 131 of slot 130 remains generally aligned with the longitudinal axis 105 of distal handle piece 104.

From the diagrams it may thus be seen that slot pin/fastener 116 serves two purposes; namely (a) as a third pivot point providing force multiplication in conjunction with blade pivot fastener 110 and handle pivot fastener 112, and (b) it acts as the pin in slot 114, thereby returning the tool to an open state in conjunction with return spring 118.

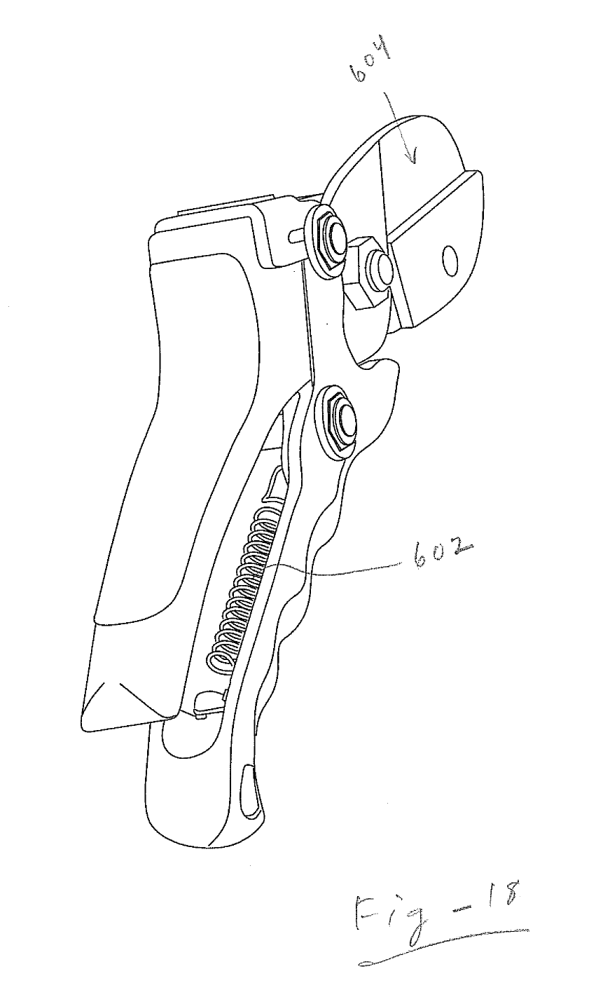

FIGS. 16, 17 are drawings of the tool as shown in FIGS. 1, 2 but with portions made transparent to better show component placement. With the handles 100, 104 squeezed closed, latch 120 may be moved proximally such that latch hook 122 engages with latch catch 124. This is accomplished without any additional parts or springs, and the biasing of return spring 118 provides sufficient friction between the latch hook 122 and catch 124 to keep the blade and jaw closed.

Note return spring 118 may be advantageously hidden in the cavity of handle 104, best seen in the oblique views of FIG. 5, 8. This configuration keeps the spring from pinching a user, and also helps to keep dirt and debris from clogging or rusting the spring. However, the invention is not limited in terms of handle length (i.e., hand pruners and lopping type tools may be accommodated), and anvil-type cutting action may be used. FIG. 18 shows an alternative embodiment of the invention seen from different perspectives having a more exposed return spring 602 and anvil cutters 604. Operation of the tool shown in FIG. 16 is the same as that described with reference to FIG. 13, however.

I claim:

1. A pruning tool, comprising:
a proximal handle coupled to a jaw;
a blade component pivotably coupled to the jaw through a blade pivot;
a distal handle pivotably coupled to the proximal handle through a handle pivot spaced apart from the blade pivot, the distal handle having a longitudinal cavity with a slot pin;
the blade component having one end with a blade that engages with the jaw and an opposing end with an elongated slot that engages with the slot pin;
a return spring disposed in the cavity and configured to pull on the opposing end of the blade component, thereby facilitating:
a closed configuration wherein the slot pin is in the slot toward the blade pivot and the blade is adjacent the jaw, and
an open configuration wherein the slot pin is in the slot away from the blade pivot and the blade is spaced apart from the jaw

2. The pruning tool of claim 1, wherein the jaw forms part of jaw component attached to the proximal handle.

3. The pruning tool of claim 1, wherein the jaw bypasses the blade.

4. The pruning tool of claim 1, wherein the jaw forms an anvil against which the blade strikes.

5. The pruning tool of claim 1, wherein the proximal and distal handles are operated with a single hand of a user.

6. The pruning tool of claim 1, wherein the proximal and distal handles are operated with both hands as a lopping tool.

7. The pruning tool of claim 1, wherein the return spring is hidden behind a panel.
